(19) United States
(12) Patent Application Publication
(10) Pub. No.: US 2014/0281132 A1
(43) Pub. Date: Sep. 18, 2014

(54) METHOD AND SYSTEM FOR RAM CACHE COALESCING

(71) Applicants: Marielle Bundukin, Hayward, CA (US); King Ying Ng, Fremont, CA (US); Steven T. Sprouse, San Jose, CA (US); William Wu, Cupertino, CA (US); Sergey Anatolievich Gorobets, Edinburgh (GB); Liam Parker, Edinburgh (GB); Alan David Bennett, Edinburgh (GB)

(72) Inventors: Marielle Bundukin, Hayward, CA (US); King Ying Ng, Fremont, CA (US); Steven T. Sprouse, San Jose, CA (US); William Wu, Cupertino, CA (US); Sergey Anatolievich Gorobets, Edinburgh (GB); Liam Parker, Edinburgh (GB); Alan David Bennett, Edinburgh (GB)

(21) Appl. No.: 13/838,582

(22) Filed: Mar. 15, 2013

(51) Int. Cl. G06F 12/02

(52) U.S. Cl. CPC G06F 12/0246
USPC 711/103

(57) ABSTRACT

A system and method for coalescing data fragments in a volatile memory such as RAM cache is disclosed. The method may include storing multiple data fragments in volatile memory and initiating a single write operation to flash memory only when a predetermined number of data fragments have been received and aggregated into a single flash write command. The method may also include generating a binary cache index delta that aggregates in a single entry all of the binary cache index information for the aggregated data fragments. A memory system having a non-volatile memory, a volatile memory sized to at least store a number of data fragments equal to a physical page managed in a binary cache of the non-volatile memory, and a controller is disclosed. The controller may be configured to execute the method of coalescing data fragments into a single flash write operation described above.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device.

Some flash memory management systems employ self-caching architectures for data buffering and data caching. For example, caching may be used for data buffering where data received from the host device is first stored in a portion of the memory designated as the cache and is later copied to a portion of the flash memory designated as a main storage area (such as a multi-level cell (MLC) type flash memory). As another example, caching may be used for control data storage to improve operation time. Control data may include mapping tables and other memory management data used by in the flash memory.

When a host device sends a write command with data to a flash memory device, it is typically desirable to write that data into the flash memory as quickly as possible to make room for a next data write command and avoid making the host wait. Typically, a flash memory device will write received data into the cache portion of memory as soon as it is received. However, because the process of writing into flash memory generally takes a fixed amount of time for each write operation, the pattern of data writes from a host can slow down the ability of a flash memory device to handle the influx of data, particularly when the host writes data in small fragments.

### SUMMARY

In order to address the problem noted above, a method and system for coalescing writes of data fragments received from a host prior to writing the data fragments into flash memory is disclosed.

According to a first aspect of the invention, a method of storing data received from a host system is disclosed. The method includes, in a memory device having a non-volatile memory, a volatile memory and a controller in communication with the non-volatile memory and volatile memory, the controller receiving data fragments from the host system. Each data fragment consists of an amount of data less than a physical page size managed in the non-volatile memory. The method continues with storing the data fragments in the volatile memory as they are received and, upon receiving a predetermined number of the data fragments, aggregating that predetermined number of data fragments into a single write command having a cumulative amount of data equal to the physical page size managed in the flash memory. Upon aggregating the predetermined number of data fragments, the cumulative amount of data aggregated in the single write command is then written in one programming operation into the non-volatile memory.

According to another aspect, a mass storage memory system, includes an interface adapted to receive data from a host system, a volatile memory, a non-volatile memory, and a controller in communication with the interface, volatile memory and the non-volatile memory. The controller is configured to receive data fragments from the host system, where each data fragment contains an amount of data less than a physical page size managed in the non-volatile memory. The controller is further configured to store the data fragments in the volatile memory as they are received and, upon receiving a predetermined number of the data fragments, aggregate the predetermined number of data fragments into a single write command having a cumulative amount of data equal to the physical page size managed in the flash memory. Upon aggregating the predetermined number of data fragments, the controller writes the cumulative amount of data aggregated in the single write command in one programming operation into the non-volatile memory.

In different implementations, the data aggregated in the single write command may include control data generated by the controller containing index information on a location for the data in the non-volatile memory. The index information may be aggregated into a single entry having index information for all of the data fragments in the predetermined number of data fragments. In other alternative implementations, the method and system may, if a predetermined amount of time elapses prior to receiving the predetermined number of data fragments, aggregate data fragments currently stored in the volatile memory into an abbreviated single write command having less than the predetermined number of data fragments; and then write the abbreviated single write command to the non-volatile memory.

### BRIEF DESCRIPTION OF THE DRAWINGS

FIG. 1 is a block diagram of a memory system.

FIG. 2 illustrates a block diagram of an exemplary flash controller design for use in the system of FIG. 1.

FIG. 3 illustrates a primary and secondary address table arrangement to manage data in the memory system of FIG. 1.

FIG. 4 is a flow diagram illustrating a method of coalescing multiple data fragments into a single flash memory write operation according to one embodiment.

FIG. 5 illustrates a sequence of flash write operations where data fragments are written in separate flash write operations.

FIG. 6 illustrates a sequence of flash write operations according to the method of FIG. 4 where multiple data fragments are coalesced into a single flash write operation.

### BRIEF DESCRIPTION OF THE PRESENTLY PREFERRED EMBODIMENTS

A flash memory system suitable for use in implementing aspects of the invention is shown in FIG. 1. A host system 100 stores data into, and retrieves data from, a storage device 102. The storage device 102 may be embedded in the host system 100 or may exist in the form of a card or other removable drive, such as a solid state disk (SSD) that is removably connected to the host system 100 through a mechanical and electrical connector. The host system 100 may be any of a number of fixed or portable data generating devices, such as a personal computer, a mobile telephone, a personal digital assistant (PDA), or the like. The host system 100 communicates with the storage device over a communication channel 104.

The storage device 102 contains a controller 106 and a memory 110. As shown in FIG. 1, the controller 106 includes a processor 108 and a controller memory 112. The processor 108 may comprise a microprocessor, a microcontroller, an application specific integrated circuit (ASIC), a field programmable gate array, a logical digital circuit, or other now known or later developed logical processing capability. The controller memory 112 may include volatile memory such as random access memory (RAM) 114 and/or non-volatile memory, and processor executable instructions 116 for handling memory management.

One or more types of data may be cached in RAM 114 in storage device 102. One type of data that may be cached in storage device 102 is host data, which is data sent to or received from the host device 100. Another type of data that may be cached in storage device 102 is control data. Other types of data for caching are contemplated. The memory 110 may include non-volatile memory (such as NAND flash memory). One or more memory types may compose memory 110, including without limitation single level cell (SLC) type of flash configuration and multi-level cell (MLC) type flash memory configuration. The SLC flash may be configured as a binary cache 118 and SLC or MLC may be used as main storage 120.

In one implementation, the processor 108 of the storage device 102 may execute memory management instructions 116 (which may be resident controller memory 112) for operation of the memory management functions, such as detailed in FIG. 4. The memory management functions may control the assignment of the one or more portions of the memory within storage device 102, such as within controller memory 112. For example, memory management functions may allocate a RAM portion 114 of controller memory 112 for permanent data cache, may allocate a RAM portion of controller memory 112 for temporary data cache, or may reclaim the RAM portion allocated to temporary data cache for another purpose. One, some, or all of the functions of the memory management functions may be performed by one or separate elements within the storage device 102. For example, allocating memory regions for temporary data cache may be performed by Media Management Layer (MML) firmware, and reclaiming a temporary data cache may be performed by Data Path Layer (DPL) firmware. The temporary data cache may be located in one or multiple shared memory regions, such as TRAM 204 or BRAM 212 described below.

FIG. 2 illustrates a more detailed block diagram of certain elements of controller 106 of FIG. 1 including one arrangement of volatile memory, and is one example of a flash controller design that may be used for controller 106. The flash controller design includes a host interface module 202 that provides the physical and electrical interface to the host system 10. The flash controller design may further include one or more volatile memories. As shown in FIG. 2, flash controller design may include multiple volatile memories, such as transfer RAM (TRAM) 204, buffer RAM (BRAM) 212, and auxiliary RAM (ARAM) 206. The examples of ARAM, BRAM and TRAM are merely for illustration purposes only. Fewer or greater numbers of volatile memories may be used. Further, other types of RAM or different combinations of RAM may be used.

ARAM 206 may be RAM provisioned for control data caching. In this way, ARAM 206 may be considered a permanent control data caching area. For example, ARAM 206 may contain a group allocation table (GAT) page cache. Part or all of the control data stored in memory 110 may be stored in cache RAM in controller 106 to improve operation speed. TRAM 204 may include a data buffer 208 that is provisioned for host data caching for host data to/from flash 214 (e.g. binary cache 118). In this way, TRAM 204 may be considered a permanent host data caching area. In one embodiment, the TRAM data buffer 208 may be sized to hold at least a number of host data fragments that equal an amount of data equal to a physical page size managed in flash memory, such as the binary cache 118. The flash memory 214 may be divided into one or more different portions (such as four portions as illustrated in FIG. 2), with each portion being associated with a different flash interface module 210, and a different section of data buffer 208. More or fewer portions of flash memory 214 may be used. The flash interface module 210 may include BRAM 212, which may be provisioned for error handling and/or chip-to-chip copy.

Referring now to FIG. 3, as is typical for a host, the host system 100 utilizes a host file system that maintains a logical address range 302 for all logical block addresses (LBAs) that have been assigned by the host system 100 to data. These LBAs are grouped into logical groups (LGs) 304. As part of the process of writing and erasing data having LBAs that fall within specific LGs, certain fragments of LGs may be written into the binary cache 118 portion of the flash memory 110 rather than to the main storage 120 portion of the flash memory 110. As discussed in greater detail below, according to one embodiment, data fragments are not written immediately to the binary cache 118 and are first stored in volatile memory, such as RAM 114 until certain conditions are met.

When fragments of LGs are written into the binary cache 118, they are mapped in a table referred to as a binary cache index (BCI) 306 to track the logical to physical address relationship for a data fragment 308 associated with a LG currently written into a binary cache block 310. Although the binary cache indices 306 are one type of control data that is typically stored in the binary cache portion of flash memory 110, a copy of all or a portion of the binary cache indices 312 may also be maintained (cached) in RAM 114 due to frequent use or recent use. Logical group address tables (GAT) 314 are kept in main storage flash memory 120. The GAT pages 314 provide the logical to physical mapping for logical groups of data and, as with the binary cache indices 306, a copy of some or all of the GAT pages may also be cached in RAM 114 in the storage device 102. The cached GAT pages 316 point to the physical locations for the update or intact blocks in main storage flash memory 318 for each of the respective logical groups.

In the embodiment illustrated in FIG. 3, the GAT 314, 316 is considered the primary address table for logical group addresses and is shown with a granularity of one GAT page for each logical group. The binary cache index 306, 312, is also referred to herein as the secondary address table. In FIG. 3 the granularity of the BCI is sector level rather than page level. In different embodiments, the logical group size can equal a block, a sub-block (an amount of data less than a block) or a unit not related to block size.

Control data may include data related to managing and/or controlling access to data stored in memory 110. The binary cache 118 may store up-to-date fragments of the logical groups (LGs). The main storage may comprise the data storage for the LGs. Control data may be used to manage the entries in memory, such as entries in binary cache 118 and main storage 120. For example, a binary cache index (BCI) may receive a Logical Block Address (LBA), and may map/point to the most up-to-date fragment(s) of the LG in binary cache 118. The GAT may receive the LBA address and map to the physical location of the LG in the main storage 120.

The processor 108 (executing the memory management instructions 23) may assign one or more portions in memory (such as volatile memory) for caching of the one or more types of data. For example, the processor 108 may assign or allocate portions of volatile memory in controller memory 112 as one or more cache storage areas, as discussed in more detail below. The one or more cache storage areas in controller memory 112 may include a portion (or all) of the BCI and GAT that is stored in flash memory 110.

The processor 108 may assign an area of volatile memory as a “permanent” cache storage area, which is an area that cannot be reclaimed by the processor 108 for a different purpose (such as for caching of a different type of data). The processor 108 may also assign an area of volatile memory as a “temporary” cache storage area, which is an area that can be reclaimed by the memory management functions for a different purpose (such as for caching of a different type of data). The processor 108 may determine whether there is a storage area available for use as a temporary data cache area. If so, the processor 108 may assign the available storage area for use as the temporary data cache area. The available storage area may be used as the temporary data cache area until the available storage area is reclaimed for another purpose.

As discussed above, data fragments 308 will eventually be written to binary cache blocks. However, when data fragments 308 are first received at a storage device 102, they are stored in volatile memory such as TRAM 204 with other volatile memory in the controller 106. Referring now to FIG. 4, when a data fragment is received, the controller will store the received data fragment in the RAM cache (e.g., TRAM 304) while it maintains a count of how many fragments have been received (at 402, 404). A controller 106 monitors the number of data fragments in RAM in order to determine when enough data fragments have been received to be able to send a complete physical page worth of data to the binary cache 118 in the flash memory 110. Assuming that all data fragments are of a same predetermined size and that the physical page size for the binary cache 118 is an integer multiple of that predetermined size, the controller 106 may count the received data fragments up to the number necessary to fill a complete physical page.

If a predetermined number of data fragments have been received (at 406) then an aggregated binary cache index entry is generated. The aggregated binary cache index entry, also referred to herein as a BCI delta, includes location information in the binary cache for each of the received data fragments that are to be aggregated and sent in a single flash write message to the binary cache. The BCI delta may be an entry with multiple pointers, each pointer directed to a different data fragment to be aggregated (at 410). The controller then coalesces (e.g. aggregates) the received fragments and the BCI delta into a single command having a payload size of one binary cache physical page (at 412). The information in a BCI delta may have a same data size as one of the host data fragments.

After coalescing the BCI delta and the data fragments, the controller then writes the data fragments and corresponding BCI delta index entry to the binary cache 118 in a single flash write operation (at 414). Alternatively, if the predetermined number of data fragments has not yet been received by the controller 106, then the controller continues to wait and store data fragments in volatile memory until enough data fragments have been received to complete the binary cache size physical page of data. Thus, in a first embodiment, the decision for when the controller 106 will send data fragments that have been received and stored in controller memory 112 may be exclusively based on whether the predetermined number of fragments necessary to generate a physical page worth of data have been received.

In an alternative embodiment, the process may optionally include the additional criteria of monitoring an elapsed time from when the first data fragment currently in the controller memory 112 was received. For example, if one or more data fragments have been received, but the predetermined number has not yet been received, then the controller 106 may look at an elapsed time from when the first of the data fragments currently in controller RAM was received and, if the time is greater than a predetermined amount of time (at 406, 408) then the controller may send to the binary cache whatever data fragment or fragments (currently less than the predetermined number) are currently in the volatile controller memory. The predetermined time may be a fixed or variable time measured as an elapsed time since the first of the fragments currently in volatile memory was received. The controller may include an internal timer function that provides a time stamp to the first received data fragment and then periodically checks the timer to see if the time difference between the current time and the time stamp has reached a threshold. The threshold may be set to any of a number of lengths of time, for example 5 seconds, at the time of manufacture.

This abbreviated single write message would be assembled by generating an abbreviated BCI delta that includes location information for the one or more data fragments (at 410) and then coalescing the one or more data fragments and the abbreviated BCI delta entry into an abbreviated single write command. This abbreviated single write command would be sent into the binary cache and written in a single flash write operation. Thus, although the optimal amount of data fragments would not be sent in this embodiment, the optional steps of also determining whether a predetermined amount of time has elapsed would permit the controller to avoid unnecessary delays in getting data fragments into the binary cache if the host is not particularly active or if the number of data fragments are very low and infrequent. The process of storing data fragments in volatile memory, coalescing the different data fragments until a predetermined amount have been reached, or optionally, until a predetermined amount of time has elapsed, may be continually repeated.

As part of executing the process described above with respect to FIG. 4, the controller 106 may distribute the tasks involved in the process among different process modules in the controller. For example, when host write commands with data fragments are received they may be first passed through an interface, such as a serial ATA protocol interface and a native command queuing (NCQ) scheduler within the front end firmware of the controller to help start the processing of the data fragments. The data fragment may be passed through a cache layer code in the controller that coalesces each data fragment using the volatile memory, such as the data buffer 208 in TRAM 204. The memory management layer (MML) may then receive coalesced data from the TRAM 204 and decide when to write the data into the binary cache 118. The MML firmware in the controller may then mark this new set of coalesced data fragments in the corresponding BCI delta that is generated. The low level sequencer in the flash memory will run an error correction code (ECC) check on the data before passing it to a flash control layer managed by the controller. The flash control layer may then determine the flash write sequence to program the aggregated data fragments into a full physical page (e.g. a binary cache). The data may then be addressed by the most recent binary cache index and the process repeated.

Referring to FIGS. 5 and 6, hypothetical timing diagrams are shown regarding the programming of data fragments without coalescing (FIG. 5) and the timing of programming with coalescing (FIG. 6). In the example of FIGS. 5 and 6, it is assumed that a data fragment size is 4 kilobytes (4 k) and that the physical page size of the binary cache in flash is 16 kilobytes (16 k). In the timeline 500 of FIG. 5, it is assumed that the host sends four consecutive data fragments 502 and that each of these fragments is processed to attach a binary cache index 504 entry (here, a pointer to a single data fragment) and then sent to the binary cache (which may be NAND flash memory) for programming. Because each programming cycle 506 to the binary cache 118 is typically a fixed amount of time, in this instance assumed to be 400 microseconds (μs), regardless of whether the data payload (e.g. the physical page of available space for the flash write operation) includes a full physical page of data to be written, the write time for a non-coalesced group of four data fragment rights would hypothetically be 1,600 microseconds.

In contrast, as illustrated in the time line 600 of FIG. 6, a memory system incorporating the embodiments above of coalescing in RAM a group of data fragments sufficient to fill a complete physical page of the binary cache may significantly decrease the amount of programming time to program the same number of fragments. For example, in FIG. 6, assuming that the payload for a single write to be sent to the binary cache would include multiple fragments 602 and the BCI delta 604 containing index information for all of the coalesced fragments, into one binary cache programming command, this one command would then take the same assumed 400 microseconds for programming for a single flash programming operation. Accordingly, the memory device's performance, when writing fragments to the binary cache by coalescing the fragments as described herein, may potentially be improved significantly.

Although certain NAND programming times, data fragment sizes, and physical page sizes have been assumed in the examples above, any of a number of different programming timing, data fragment sizes, and physical page sizes, or combinations thereof, may be implemented in different embodiments.

As disclosed above, a system and method may gather multiple fragments of received host data in controller RAM before issuing a single program command to the NAND. Instead of programming one received data fragment at a time to the NAND as in the current write algorithms, the disclosed system and method allows programming multiple fragments at a time. Therefore, coalescing data fragment writes from a host in RAM in the memory device may effectively reduce the amount of NAND programming operations. Whenever a write command with a data fragment is received from the host, the memory device stores the fragment temporarily in the controller RAM memory and/or in the NAND internal memory latches. When a favorable number of fragments are gathered, the controller will then move this group of fragments from the temporary location in RAM to the NAND flash cells of the flash memory using a minimal number of programming operations.

In an alternative embodiment, the process of improving the efficiency of writing to NAND flash memory from RAM may further include a mechanism for minimizing the number of control writes to the NAND for each fragment. Instead of a separate control write for each data fragment in the BCI, a BCI delta is disclosed where index information that is written into the NAND references multiple fragments in a single BCI delta entry. Combining these two features may improve the amount of data that is programmed per die page and improves the random input/output performance of the memory device. Ideally, the size of the total amount of fragments that are gathered to be programmed at the same time should be smaller than or equal to a physical page size in NAND (e.g. the binary cache). In this way, the RAM cache coalescing steps noted above may help to reduce the amount of NAND programming operations by using each NAND programming operation more efficiently.

It is intended that the foregoing detailed description be understood as an illustration of selected forms that the invention can take and not as a definition of the invention. It is only the following claims, including all equivalents, that are intended to define the scope of this invention.

We claim:

1. A method of storing data received from a host system, the method comprising:
in a memory device having a non-volatile memory, a volatile memory and a controller in communication with the non-volatile memory and volatile memory, the controller:
receiving data fragments from the host system, each data fragment comprising an amount of data less than a physical page size managed in the non-volatile memory;
storing the data fragments in the volatile memory as they are received;
upon receiving a predetermined number of the data fragments, aggregating the predetermined number of data fragments into a single write command having a second amount of data equal to the physical page size managed in the flash memory; and
writing the second amount of data in the single write command to the non-volatile memory.

2. The method of claim 1, further comprising:
if a predetermined amount of time elapses prior to receiving the predetermined number of data fragments:
aggregating data fragments currently stored in the volatile memory into an abbreviated single write command having less than the predetermined number of data fragments; and
writing the abbreviated single write command to the non-volatile memory.

3. The method of claim 1, wherein:
the non-volatile memory comprises a binary cache and a long term memory;
the physical page size managed in the flash memory comprises a physical page size of data managed in the binary cache; and
writing the data in the single write command to the non-volatile comprises writing the data in the single write command to the binary cache.

4. The method of claim 1, further comprising generating an aggregated index entry identifying a respective location in the non-volatile memory for each of the aggregated data fragments in the single write command.

5. The method of claim 4, wherein generating the aggregated index entry comprises aggregating pointer information for each aggregated data fragment into a single entry.

6. The method of claim 4, wherein the second amount of data in the single write command comprises a sum of a size of each aggregated data fragment and a size of the aggregated index entry for the aggregated data fragments.

7. The method of claim 6, wherein each data fragment has a same size.

8. A mass storage memory system, comprising:
an interface adapted to receive data from a host system;
a volatile memory;
a non-volatile memory; and
a controller in communication with the interface, volatile memory and the non-volatile memory, wherein the controller is configured to:
receive data fragments from the host system, each data fragment comprising an amount of data less than a physical page size managed in the non-volatile memory;
store the data fragments in the volatile memory as they are received;
upon receiving a predetermined number of the data fragments, aggregate the predetermined number of data fragments into a single write command having a second amount of data equal to the physical page size managed in the flash memory; and
write the second amount of data in the single write command to the non-volatile memory.

9. The mass storage memory system claim 8, wherein the controller is further configured to:
if a predetermined amount of time elapses prior to receiving the predetermined number of data fragments:
aggregate data fragments currently stored in the volatile memory into an abbreviated single write command having less than the predetermined number of data fragments; and
write the abbreviated single write command to the non-volatile memory.

10. The mass storage memory system of claim 8, wherein:
the non-volatile memory comprises a binary cache and a long term memory;
the physical page size managed in the flash memory comprises a physical page size of data managed in the binary cache; and
the controller is configured to write the data in the single write command to the binary cache.

11. The mass storage memory system of claim 8, wherein the controller is further configured to generate an aggregated index entry identifying a respective location in the non-volatile memory for each of the data fragments aggregated in the single write command.

12. The mass storage memory system of claim 11, wherein to generate the aggregated index entry, the controller is further configured to aggregate pointer information for each aggregated data fragment into a single entry.

13. The mass storage memory system of claim 11, wherein the second amount of data in the single write command comprises a sum of a size of each aggregated data fragment and a size of the aggregated index entry for the aggregated data fragments.

14. The mass storage memory system of claim 13, wherein each data fragment has a same size.

15. The mass storage memory system of claim 8, wherein the volatile memory comprises random access memory RAM sized to store at least the predetermined number of data fragments.

16. The mass storage memory system of claim 15, wherein the RAM is internal to the controller.

17. The mass storage memory device of claim 15, wherein a size of each of the data fragments is identical and the physical page size managed in the non-volatile memory comprises a whole number multiple of the size of each of the data fragments.
